(19) United States
(12) Patent Application Publication
(10) Pub. No.: US 2009/0184671 A1
(43) Pub. Date: Jul. 23, 2009

(54) DISCHARGE LAMP LIGHTING APPARATUS AND SEMICONDUCTOR INTEGRATED CIRCUIT

(75) Inventor: Kengo KIMURA, Niiza-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sanken Electric Co., Ltd., Niiza-shi (JP)

(21) Appl. No.: 12/357,685

(22) Filed: Jan. 22, 2009

(30) Foreign Application Priority Data
Jan. 23, 2008 (JP) 2008-012615

(51) Int. Cl. H05B 41/36

(52) U.S. Cl. 315/308

(57) ABSTRACT

A discharge lamp lighting apparatus has a switch circuit to convert a DC voltage into an AC voltage, a transformer, a discharge lamp, an error amplifier of a reference voltage and a voltage representative of a lamp current, a control circuit generating a PWM control signal, and a soft start circuit to carry out, at the start of a lighting operation, a soft start operation that gradually extends ON intervals of the PWM control signal to gradually increase the lamp current upto a target lamp current. The soft start circuit carries out the soft start operation in such a way that an increment in ON intervals of the PWM control signal in a period from when the discharge lamp lights to when the target lamp current is attained is smaller than that in a period from when the lighting operation starts to when the discharge lamp lights.

### BACKGROUND OF THE INVENTION

1. Field of the Invention

The present invention relates to a discharge lamp lighting apparatus and a semiconductor integrated circuit, for lighting a discharge lamp used in, for example, a liquid crystal display. In particular, the present invention relates to a soft start technique employed by the discharge lamp lighting apparatus and semiconductor integrated circuit, for slowly turning on the discharge lamp.

2. Description of the Related Art

An example of the soft start technique conducted by a discharge lamp lighting apparatus is described in Japanese Unexamined Patent Application Publication No. 2004-166445. FIG. 1 is a circuit diagram schematically illustrating a control IC in the discharge lamp lighting apparatus of the related art.

The related art employs a transformer having primary and secondary windings, a semiconductor switch circuit to pass a current from a DC power source to the primary winding of the transformer, a current detector 211 to detect a current passed to a discharge lamp connected to the secondary winding of the transformer, a voltage detector 212 to detect a voltage applied to the discharge lamp, an oscillation (OSC) block 201 to generate a triangular signal, a slow start block 205 to generate a gradually-increasing slow start voltage at the start of a lighting operation, and a PWM control signal generator 214. The PWM control signal generator 214 compares the triangular signal with one of the slow start voltage and an error signal depending on the magnitudes of the slow start voltage and error signal, the error signal being based on a current detection signal from the current detector 211 and a voltage detection signal from the voltage detector 212. Based on the comparison result, the PWM control signal generator 214 generates a PWM control signal to turn on/off FETs 101 to 104 (not illustrated) of a full-bridge arrangement in the semiconductor switch circuit.

At the start of a lighting operation, the related art carries out a soft start operation with the use of the slow start block 205, to gradually widen a pulse width, i.e., gradually increase a voltage and current applied to the discharge lamp, so that the discharge lamp may not receive excessive stress.

FIG. 2 illustrates operational waveforms in the apparatus of FIG. 1 at the start of a lighting operation. In FIG. 2, “FBOUT” is a signal FB received by the PWM control signal generator 214 and represents an error signal between a detected current of the discharge lamp and a reference voltage Vref2 and an error signal between a detected voltage of the discharge lamp and a reference voltage Vref3. Regarding symbols of FIG. 2, “CF” is an output from the OSC block 201 to the PWM control signal generator 214, “SS” is an output from the slow start block 205 to the PWM control signal generator 214, “DRIV1” is a PWM control signal to drive the FET 101 (not illustrated) connected to a negative input terminal P1 and the FET 102 (not illustrated) connected to a terminal N1, “DRIV2” is a PWM control signal to drive the FET 103 (not illustrated) connected to a negative input terminal P2 and the FET 104 (not illustrated) connected to a terminal N2, “CCFL voltage” is the voltage of the discharge lamp, and “CCFL current” is the current of the discharge lamp.

At time t10, the slow start block 205 starts to gradually increase the slow start voltage SS. At time t11, the slow start voltage SS reaches a voltage of the triangular signal. At this time, the PWM control signal generator 214 generates the PWM control signals DRIV1 and DRIV2. The PWM control signal DRIV1 drives the FET 101 (not illustrated) connected to the negative input terminal P1 and the FET 102 (not illustrated) connected to the terminal N1, and the PWM control signal DRIV2 drives the FET 103 (not illustrated) connected to the negative input terminal P2 and the FET 104 (not illustrated) connected to the terminal N2.

As a result, the voltage applied to the discharge lamp gradually increases, and at time t12, reaches a lighting start voltage Vst of the discharge lamp, to light the discharge lamp. At this time, a current starts to pass through the discharge lamp, and at time t13, reaches a constant value.

### SUMMARY OF THE INVENTION

A discharge lamp such as a cold cathode fluorescent lamp (CCFL) used as a backlight of a liquid crystal TV does not light until a start-up voltage applied thereto reaches a lighting start voltage. Namely, according to the above-mentioned related art, the discharge lamp lights only when a voltage applied thereto based on a charging voltage of a soft start capacitor 141 linearly increases up to the lighting start voltage Vst of the discharge lamp.

As results, the related art involves a long lighting delay time Tdy from the start of a lighting operation (t10) to when the discharge lamp actually lights (t12). Such a long delay time is not preferable when the apparatus is used in, for example, a home TV.

According to the present invention, provided is a discharge lamp lighting apparatus and a semiconductor integrated circuit, capable of minimizing a lighting delay time between when a lighting operation starts and when a discharge lamp actually lights.

A first aspect of the present invention provides a discharge lamp lighting apparatus including a switch circuit having a plurality of switching elements to be turned on and off to convert a DC voltage of a DC power source into an AC voltage; a transformer having a primary winding connected to the switch circuit and a secondary winding to output an AC voltage; a discharge lamp configured to be lighted according to the AC voltage from the secondary winding of the transformer; an oscillator configured to generate a triangular signal; an error amplifier configured to output, as an error signal, an error voltage between a reference voltage and a voltage representative of a lamp current passed to the discharge lamp; a control circuit configured to generate a PWM control signal by comparing the triangular signal from the oscillator with the error signal from the error amplifier, and according to the PWM control signal, turn on/off the switching elements; and a soft start circuit configured to carry out, at the start of a lighting operation, a soft start operation that gradually extends ON intervals of the PWM control signal to gradually increase the lamp current passed to the discharge lamp up to a target lamp current. The soft start circuit carries out the soft start operation in such a way that an increment in ON intervals of the PWM control signal in a period from when the discharge lamp lights to when the target lamp current is attained is smaller than that in a period from when the lighting operation starts to when the discharge lamp lights.

According to a second aspect of the present invention that is based on the first aspect, the soft start circuit includes a soft start capacitor. A voltage of the soft start capacitor is compared with the triangular signal and the soft start operation is carried out according to the PWM control signal that is based on the voltage of the soft start capacitor. The soft start capacitor is charged with a first current when the lighting operation starts, and when the voltage of the soft start capacitor reaches a predetermined voltage, with a second current until the target lamp current is attained, the second current being smaller than the first current.

A third aspect of the present invention provides a semiconductor integrated circuit for controlling a plurality of switching elements that intermittently supply power from a DC power source to a primary winding of a transformer. The semiconductor integrated circuit includes an oscillator configured to generate a triangular signal; an error amplifier configured to output, as an error signal, an error voltage between a reference voltage and a voltage representative of a lamp current passed to the discharge lamp; a control circuit configured to generate a PWM control signal by comparing the triangular signal from the oscillator with the error signal from the error amplifier, and according to the PWM control signal, turn on/off the switching elements; a connection terminal to which a soft start capacitor is connected; and a soft start circuit configured to carry out, at the start of a lighting operation, a soft start operation that gradually extends ON intervals of the PWM control signal to gradually increase the lamp current passed to the discharge lamp up to a target lamp current. The soft start circuit includes a first constant current circuit configured to pass a first current; a second constant current circuit configured to pass a second current that is smaller than the first current; and a charging current switching circuit configured to output the first current from the first constant current circuit to the connection terminal at the start of the lighting operation, and when a voltage at the connection terminal reaches a predetermined voltage, switch the first current from the first constant current circuit to the second current from the second constant current circuit.

### BRIEF DESCRIPTION OF THE DRAWINGS

FIG. 1 is a circuit diagram schematically illustrating a control IC of a discharge lamp lighting apparatus according to a related art;

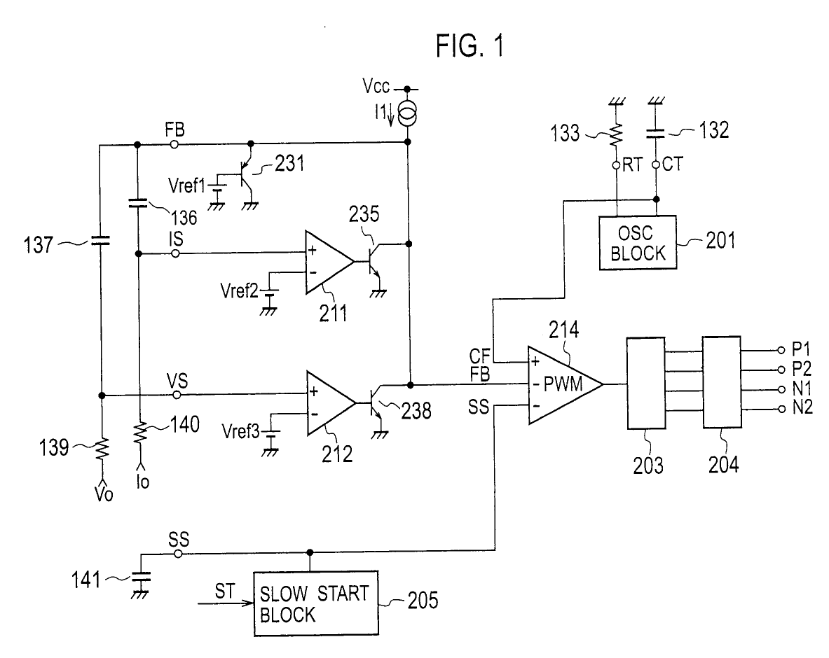

FIG. 2 is a diagram illustrating operational waveforms in the apparatus of the related art illustrated in FIG. 1 at the start of a lighting operation;

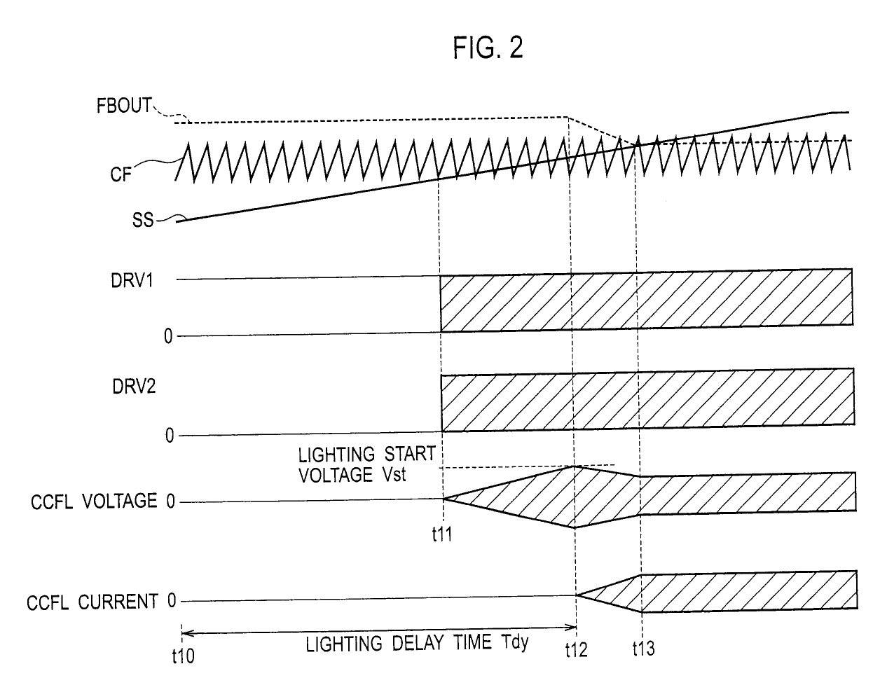

FIG. 3 is a circuit diagram illustrating a discharge lamp lighting apparatus according to Embodiment 1 of the present invention;

FIG. 4 is a diagram illustrating operational waveforms in the apparatus of Embodiment 1 illustrated in FIG. 3 at the start of a lighting operation;

FIG. 5 is a circuit diagram illustrating a discharge lamp lighting apparatus according to Embodiment 2 of the present invention;

FIG. 6 is a diagram illustrating operational waveforms in the apparatus of Embodiment 2 illustrated in FIG. 5 at the start of a lighting operation; and

FIG. 7 is a circuit diagram illustrating a discharge lamp lighting apparatus according to Embodiment 3 of the present invention.

### DESCRIPTION OF THE PREFERRED EMBODIMENT

Discharge lamp lighting apparatuses and semiconductor integrated circuits according to the embodiments of the present invention will be explained in detail with reference to the drawings.

### Embodiment 1

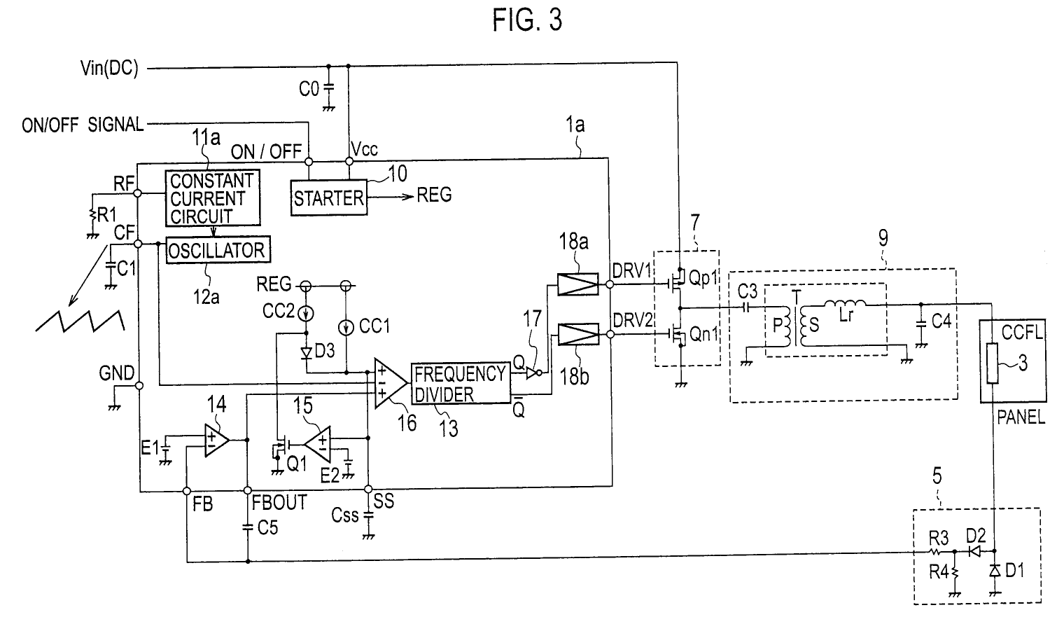

FIG. 3 is a circuit diagram illustrating a discharge lamp lighting apparatus according to Embodiment 1 of the present invention. In FIG. 3, connected between a DC power source Vin and the ground is a series circuit consisting of a high-side p-type MOSFET Qp1 (hereinafter referred to as “p-type FET Qp1”) and a low-side n-type MOSFETQn1 (hereinafter referred to as “n-type FET Qn1”). Connected between a connection point of the p- and n-type FETs Qp1 and Qn1 and the ground is a series circuit consisting of a capacitor C3 and a primary winding P of a transformer T. Ends of a secondary winding of the transformer T are connected to a capacitor C4. A reactor Lr is a leakage inductance of the transformer T.

The p-type FET Qp1 has a source connected to the DC power source Vin and a gate connected to a terminal DRV1 of a control IC 1a. The n-type FET Qn1 has a gate connected to a terminal DRV2 of the control IC 1a. The p- and n-type FETs Qp1 and Qn1 form a switch network 7.

The control IC 1a includes a starter 10, a constant current circuit 11a, an oscillator 12a, a frequency divider 13, an error amplifier 14, a comparator 15, a PWM comparator 16, an inverter 17, and drivers 18a and 18b. The control IC la is a semiconductor integrated circuit.

The constant current circuit 11a is connected through a negative input terminal RF to an end of a constant current determining resistor R1. The oscillator 12a is connected through a negative input terminal CF to an end of a capacitor C1.

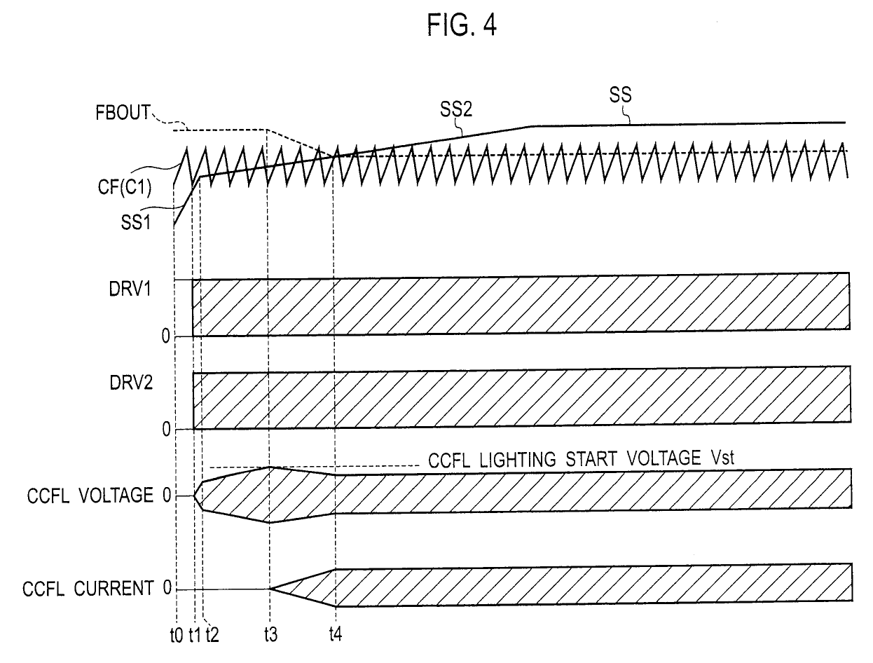

The starter 10 receives power from the DC power source Vin and generates a predetermined voltage REG, which is supplied to internal elements of the control IC 1a. The constant current circuit 11a supplies a constant current that is optionally set by the constant current determining resistor R1. The oscillator 12a charges/discharges the capacitor C1 with the constant current from the constant current circuit 11a and generates an oscillating triangular signal CF(C1). The signal CF(C1) as illustrated in FIG. 4 represents a charge/discharge voltage of the capacitor C1 at the terminal CF.

An end of the secondary winding S of the transformer T is connected to an electrode of a discharge lamp 3, which is a cold cathode fluorescent lamp (CCFL). The other electrode of the discharge lamp 3 is connected to a lamp current detector 5. The reactor Lr is a leakage inductance component. The lamp current detector 5 includes diodes D1 and D2 and a resistor R4, to detect a current passing through the discharge lamp 3 and provide a voltage proportional to the detected current. This voltage is sent through a resistor R3 and a feedback terminal FB of the control IC 1a to a negative input terminal (inverting input terminal as depicted by “−”) of the error amplifier 14.

A positive input terminal (non-inverting input terminal as depicted by “+”) of the error amplifier 14 receives a reference voltage El. The error amplifier 14 amplifies an error voltage between the voltage from the lamp current detector 5 and the reference voltage E1 and outputs the amplified error voltage to a first positive input terminal of the PWM comparator 16.

A second positive input terminal of the PWM comparator 16 is connected to a terminal SS that is connected to an end of a soft start capacitor Css. The other end of the soft start capacitor Css is grounded. The comparator (error amplifier) 15 has a negative input terminal to receive a reference voltage E2 and a positive input terminal that is connected to the second positive input terminal of the PWM comparator 16 and the soft start capacitor Css at the terminal SS.

The comparator 15 compares a voltage of the soft start capacitor Css with the reference voltage E2 and outputs the comparison result to a gate of an n-type FET Q1. Connected between the power source REG and the second positive input terminal of the PWM comparator 16 is a constant current source CC1. Also connected between the power source REG and the second positive input terminal of the PWM comparator 16 is a series circuit of a constant current source CC2 and a diode D3. A connection point of the constant current source CC2 and diode D3 is connected to a drain of the n-type FET Q1 whose source is grounded.

The soft start capacitor Css, PWM comparator 16, constant current sources CC1 and CC2, comparator (error amplifier) 15, n-type FET Q1, and diode D3 form a soft start circuit.

At the start of a lighting operation, the soft start circuit gradually increases a lamp current passing through the discharge lamp 3 up to a target lamp current. For this, the soft start circuit gradually extends ON intervals (ON pulse widths) of a PWM control signal according to a voltage at the connection terminal SS in such a way that an increment in ON intervals of the PWM control signal in a period from when the discharge lamp 3 lights to when the lamp current reaches the target lamp current is smaller than that in a period from when the lighting operation starts to when the discharge lamp 3 lights.

Switching an increment in ON intervals of a PWM control signal to another is achievable according to first and second techniques mentioned below. Although the present embodiment employs the first technique, it may also employ the second technique.

According to the first technique, the soft start circuit compares a voltage of the soft start capacitor Css with the triangular signal and carries out the soft start operation with a PWM control signal that is based on a voltage of the soft start capacitor Css. At the start of a lighting operation, the soft start circuit charges the soft start capacitor Css with a first current, and when the soft start capacitor Css reaches the predetermined voltage E2, with a second current, which is smaller than the first current, until a current passing through the discharge lamp 3 reaches a target lamp current.

When the soft start capacitor Css reaches the predetermined voltage E2, the soft start circuit switches the charging current of the soft start capacitor Css from the first current to the second current. The predetermined voltage E2 may be equal to a terminal voltage of the soft start capacitor Css at which the discharge lamp 3 lights, so that an increment in ON intervals of the PWM control signal may be switched to another when the discharge lamp 3 lights.

According to the second technique, the soft start circuit uses the PWM comparator 16 to compare a voltage of the soft start capacitor Css with the triangular signal and carries out the soft start operation according to a PWM control signal that is based on a voltage of the soft start capacitor Css. The soft start circuit charges the soft start capacitor Css with a first current in a period from when a lighting operation starts to when the discharge lamp 3 lights and with a second current, which is smaller than the first current, in a period from when the discharge lamp 3 lights to when a lamp current passed to the discharge lamp 3 reaches a target lamp current.

The charging current of the soft start capacitor Css in the period from when the discharge lamp 3 lights to when the lamp current reaches the target lamp current is smaller than that in the period from when the lighting operation starts to when the discharge lamp 3 lights, and therefore, an increment in ON intervals of the PWM control signal can easily be changed to another.

The constant current sources CC1 and CC2 form a first constant current circuit for passing the first current. The constant current source CC1 forms a second constant current circuit for passing the second current that is smaller than the first current. The comparator 15, n-type FET Q1, and diode D3 form a charging current switching circuit that outputs the first current (the sum of the constant current sources CC1 and CC2) to the connection terminal SS at the start of a lighting operation, and when a voltage at the connection terminal SS reaches the predetermined voltage E2, switches the first current to the second current (only the constant current source CC1).

The PWM comparator 16 generates a PWM control signal that is a pulse signal according to the error voltage FBOUT from the error amplifier 14 to the first positive input terminal of the PWM comparator 16, a voltage from the soft start capacitor Css to the second positive input terminal of the PWM comparator 16, and the triangular signal from the terminal CF to the negative input terminal of the PWM comparator 16.

The generated PWM control signal is frequency-divided by the frequency divider 13 that provides first and second signal groups. The first signal group is inverted by the inverter 17 and is passed through the driver 18a and terminal DRV1, to provide a first drive signal to the p-type FET Qp1. The second signal group is passed through the driver 18b and terminal DRV2, to provide a second drive signal to the n-type FET Qn1.

The first drive signal for driving the p-type FET Qp1 is generated so as to pass a current through the discharge lamp 3 with a pulse width according to the current passing through the discharge lamp 3. The second drive signal for driving the n-type FET Qn1 is generated to have substantially the same pulse width as the first drive signal and a phase difference of about 180 degrees with respect to the first drive signal. Thus, the second drive signal causes a current passing through the discharge lamp 3 in an opposite direction to the current caused by the first drive signal.

Operation of the discharge lamp lighting apparatus according to the present embodiment will be explained with reference to the timing chart of FIG. 4.

The first and second drive signals alternately turn on/off the p- and n-type FETs Qp1 and Qn1, to generate a rectangular wave voltage. The rectangular wave voltage is applied to the capacitor C3 and the primary winding P of the transformer T. Then, the capacitor C3, the leakage inductance of the transformer T, and the capacitor C4 resonate to apply a sinusoidal voltage to the discharge lamp 3.

The circuit as illustrated in FIG. 3 is configured such that resonance caused by the leakage inductance of the transformer and the capacitor C4 becomes dominant.

When the diode D1 in the lamp current detector 5 turns on due to the output from the transformer T, the diode D1 passes a current of the discharge lamp 3. When the output of the transformer T is reversed to turn off the diode D1, the diode D2 turns on to pass a current of the discharge lamp 3 through the resistor R3. As results, the resistor R3 generates a voltage representative of the current of the discharge lamp 3, i.e., a current detection signal. The resistor R4 and a capacitor C5 of a feedback circuit form an integrator (smoothing circuit).

The voltage representative of the detected lamp current from the current detector 5 is passed through the terminal FB to the negative input terminal of the error amplifier 14. The positive input terminal of the error amplifier 14 receives the reference voltage El. The error amplifier 14 amplifies an error voltage between the voltage representative of the detected lamp current and the reference voltage E1 and outputs an error signal FBOUT.

The triangular signal CF(C1) from the oscillator 12a has an inclination that is determined by charging and discharging currents passed from the capacitor C1 and oscillator 12a to the terminal CF.

The error signal FBOUT from the error amplifier 14 is supplied to the first positive input terminal of the PWM comparator 16. The triangular signal CF(C1) from the oscillator 12a is supplied to the negative input terminal of the PWM comparator 16. The soft start signal SS, i.e., the voltage of the soft start capacitor Css is supplied to the second positive input terminal of the PWM comparator 16.

At the start (time t0) of a lighting operation, the PWM comparator 16 compares the soft start signal SS with the triangular signal CF (C1). At this time, the sum of the current from the constant current source CC1 and the current from the constant current source CC2, i.e., the first current passes through the soft start capacitor Css, to charge the soft start capacitor Css. Accordingly, at the start of a lighting operation, the soft start signal SS increases along a straight line SS1 having a large inclination (large increment).

At time t1, the p- and n-type FETs Qp1 and Qn1 start to turn on/off to gradually increase a voltage applied to the discharge lamp 3.

At time t2, the soft start signal SS reaches the reference voltage E2, and therefore, the comparator 15 provides a high-level output to the gate of the n-type FET Q1 to turn on the same. This turns off the diode D3, so that only the second current from the constant current source CC1 passes through the soft start capacitor Css. Then, the soft start signal SS starts to increase along a straight line SS2 having a small inclination (small increment).

At time t3, the voltage of the discharge lamp 3 reaches the lighting start voltage Vst, so that the discharge lamp 3 lights and a lamp current starts to pass through the discharge lamp 3. At time t4, the lamp current of the discharge lamp 3 reaches a target lamp current.

In this way, the discharge lamp lighting apparatus according to the present embodiment employs the soft start circuit that makes an increment in ON intervals of a PWM control signal in a period from when the discharge lamp 3 lights to when a lamp current of the discharge lamp 3 reaches a target lamp current smaller than that in a period from when a lighting operation starts to when the discharge lamp 3 lights. Accordingly, the present embodiment can shorten an interval from when a lighting operation starts to when the discharge lamp lights. Namely, the present embodiment minimizes a lighting delay time from when a lighting operation of the discharge lamp 3 starts to when the discharge lamp 3 actually lights. In addition, the present embodiment can prevent an excessive spatter of the discharge lamp 3, thereby elongating the service life of the discharge lamp 3.

### Embodiment 2

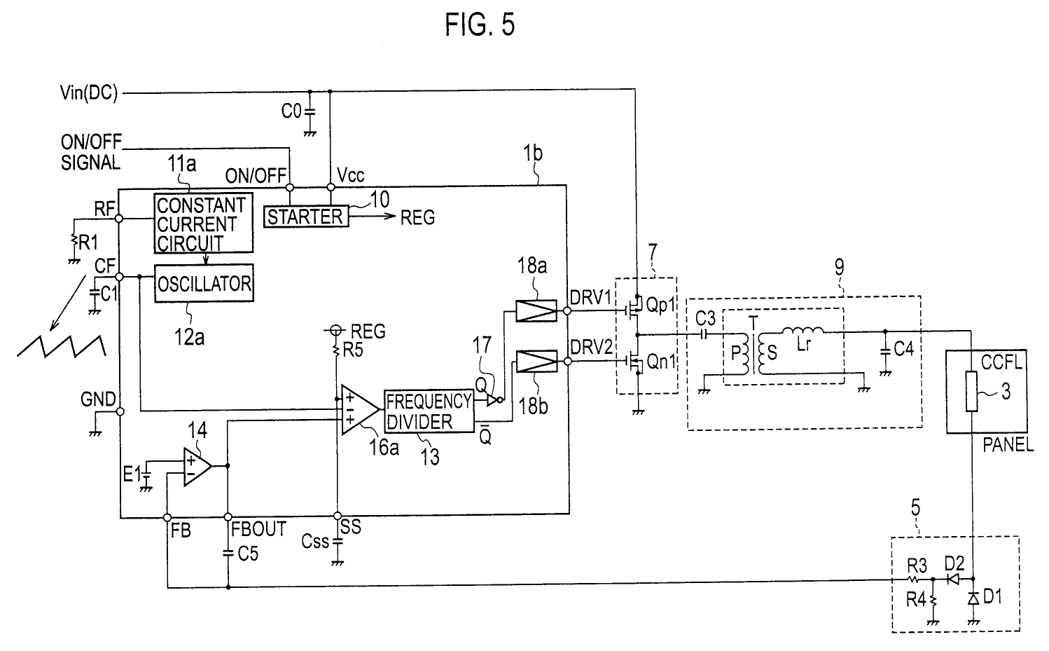

FIG. 5 is a circuit diagram illustrating a discharge lamp lighting apparatus according to Embodiment 2 of the present invention. The apparatus of the present embodiment employs a control IC 1b that omits the constant current sources CC1 and CC2, comparator 15, n-type FET Q1, and diode D3 of the soft start circuit of Embodiment 1 (FIG. 3), and instead, arranges a resistor R5 in the soft start circuit. The resistor R5 is connected between a second positive input terminal of a PWM comparator 16 and a power source REG.

The soft start circuit according to the present embodiment employs a voltage of the power source REG that is equal to or larger than a reference voltage E1 of an error amplifier 14, to charge a soft start capacitor Css through the resistor R5.

It is most preferable that the voltage of the power source REG is set to be slightly higher than the reference voltage E1 of the error amplifier 14.

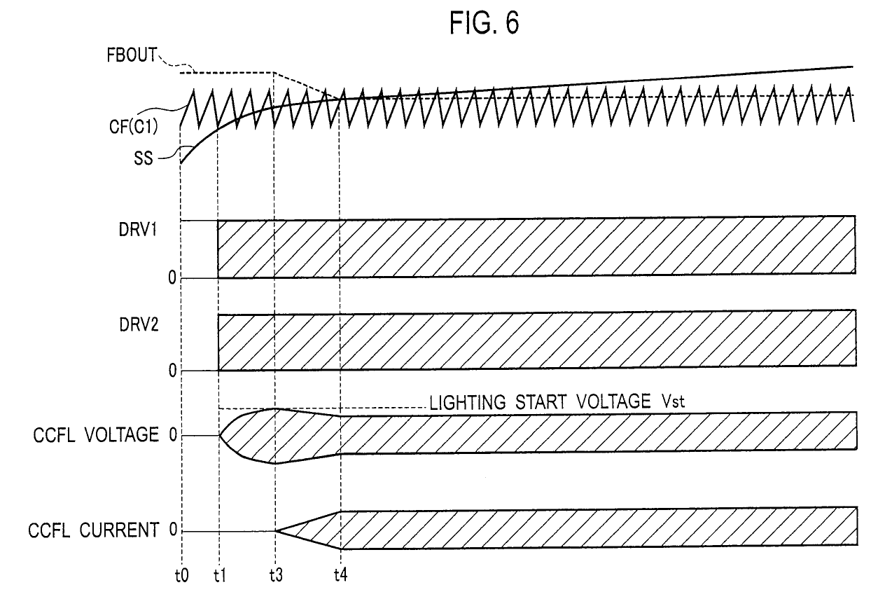

FIG. 6 is a diagram illustrating operational waveforms in the discharge lamp lighting apparatus of the present embodiment at the start of a lighting operation.

As illustrated in FIG. 6, the voltage of the soft start capacitor Css, i.e., a soft start signal SS exponentially increases. Accordingly, increments in ON intervals of a PWM control signal are large before a discharge lamp 3 lights (t0 to t3), and after the discharge lamp 3 lights (t3 to t4), are small. When the voltage of the soft start capacitor Css reaches the reference voltage E1, the lamp current to the discharge lamp 3 is controlled according to the reference voltage E1.

Consequently, Embodiment 2 provides an effect similar to that provided by Embodiment 1.

### Embodiment 3

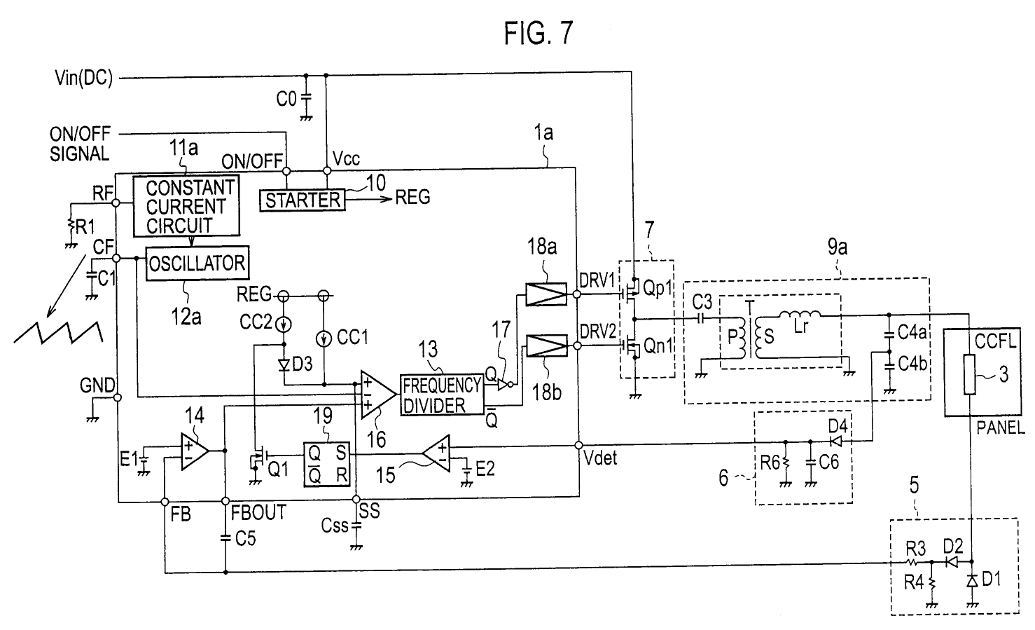

FIG. 7 is a circuit diagram illustrating a discharge lamp lighting apparatus according to Embodiment 3 of the present invention. The present embodiment is characterized in that it detects an output voltage applied to a discharge lamp 3, and according to the detected voltage, switches an inclination of a soft start signal of a soft start circuit to another.

In FIG. 7, connected between an end of the discharge lamp 3 and the ground is a series circuit composed of capacitors C4a and C4b. A connection point of the capacitors C4a and C4b is connected to an anode of a diode D4. A cathode of the diode D4 is connected to an end of a capacitor C6, an end of a resistor R6, and through a terminal Vdet, a positive input terminal of a comparator 15. The other ends of the capacitor C6 and resistor R6 are grounded. An output terminal of the comparator 15 is connected to a set terminal S of a flip-flop 19 whose output terminal Q is connected to a gate of an n-type FET Q1.

With this configuration, an output voltage applied to the discharge lamp 3 is detected at the connection point of the capacitors C4a and C4b and is converted into a DC voltage by a rectifying/smoothing circuit 6 consisting of the diode D4, capacitor C6, and resistor R6. The DC voltage is supplied to the positive input terminal of the comparator 15.

If the DC voltage from the rectifying/smoothing circuit 6 is smaller than a reference voltage E2 of the comparator 15, a first current from constant current sources CC1 and CC2 passes through a soft start capacitor Css, to thereby charge the soft start capacitor Css. As a result, a soft start signal SS increases along a straight line SS1 having a steep inclination as illustrated in FIG. 4.

When the DC voltage from the rectifying/smoothing circuit 6 reaches the reference voltage E2, the comparator 15 provides a high-level output to the set terminal S of the flip-flop 19, to turn on the n-type FET Q1. As a result, a second current from the constant current source CC1 alone passes through the soft start capacitor Css, to thereby charge the soft start capacitor Css. Accordingly, the soft start signal SS increases along a straight line SS2 having a gentle inclination as illustrated in FIG. 4.

In this way, the soft start circuit according to the present embodiment charges the soft start capacitor Css with the first current at the start of a lighting operation. When an output voltage applied to the discharge lamp 3 reaches the predetermined voltage E2, the soft start circuit charges the soft start capacitor Css with the second current, which is smaller than the first current, until a current passed to the discharge lamp 3 reaches a target lamp current. Consequently, Embodiment 3 provides an effect similar to that provided by Embodiment 1.

Namely, when the soft start capacitor Css provides a predetermined terminal voltage, the soft start circuit switches the charging current of the soft start capacitor Css to a smaller one. The predetermined voltage may be equal to a terminal voltage of the soft start capacitor Css at which the discharge lamp 3 lights, so that an increment in ON intervals of a PWM control signal may be switched to another when the discharge lamp 3 lights.

The above-mentioned Embodiments 1 to 3 employ an inverter configuration in which the two switching elements Qp1 and Qn1 are turned on/off to resonate the secondary-side resonant circuit including the leakage inductance of the transformer T, to output AC power. The present invention is not limited to this configuration. For example, the present invention may employ a full-bridge configuration employing four switching elements, or a center-tap configuration employing two switching elements, or a configuration that arranges the resonant capacitor C4 on the primary side of the transformer T.

In summary, the first aspect of the present invention employs the soft start circuit that makes an increment in ON intervals of a PWM control signal in a period from when a discharge lamp lights to when a lamp current reaches a target lamp current smaller than that in a period from when a lighting operation starts to when the discharge lamp lights. Consequently, the first aspect can shorten a time period between the start of a lighting operation and the time when a discharge lamp actually lights.

According to the second aspect of the present invention, the soft start circuit extends ON intervals of a PWM control signal according to a terminal voltage of the soft start capacitor that is charged with predetermined currents. A current for charging the soft start capacitor in a period from when a discharge lamp lights to when a current passing through the discharge lamp reaches a target lamp current is smaller than that in a period from when a lighting operation starts to when the discharge lamp lights. The second aspect can easily switch an increment in ON intervals of a PWM control signal to another.

The third aspect of the present invention provides a semiconductor integrated circuit for a discharge lamp lighting apparatus, having the soft start circuit of any one of the first and second aspects.

This application claims benefit of priority under 35 USC §119 to Japanese Patent Application No. 2008-012615, filed on Jan. 23, 2008, the entire content of which is incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A discharge lamp lighting apparatus comprising:
a switch circuit having a plurality of switching elements to be turned on and off to convert a DC voltage of a DC power source into an AC voltage;
a transformer having a primary winding connected to the switch circuit and a secondary winding to output an AC voltage;
a discharge lamp configured to be lighted according to the AC voltage from the secondary winding of the transformer;
an oscillator configured to generate a triangular signal;
an error amplifier configured to output an error signal representative of a difference between a reference value and a lamp current passing through the discharge lamp;
a control circuit configured to generate a PWM control signal by comparing the triangular signal from the oscillator with the error signal from the error amplifier, and according to the PWM control signal, turn on/off the switching elements; and
a soft start circuit configured to carry out, at the start of a lighting operation, a soft start operation that gradually extends ON intervals of the PWM control signal to gradually increase the lamp current passing through the discharge lamp up to a target lamp current,
the soft start circuit carrying out the soft start operation in such a way that an increment in ON intervals of the PWM control signal in a period from when the discharge lamp lights to when the target lamp current is attained is smaller than that in a period from when the lighting operation starts to when the discharge lamp lights.

2. The discharge lamp lighting apparatus of claim 1, wherein:
the soft start circuit includes a soft start capacitor;
a voltage of the soft start capacitor is compared with the triangular signal and the soft start operation is carried out according to the PWM control signal that is based on the voltage of the soft start capacitor; and
the soft start capacitor is charged with a first current in a period from when the lighting operation starts to when the discharge lamp lights and with a second current in a period from when the discharge lamp lights to when the target lamp current is attained, the second current being smaller than the first current.

3. The discharge lamp lighting apparatus of claim 1, wherein:
the soft start circuit includes a soft start capacitor;
a voltage of the soft start capacitor is compared with the triangular signal and the soft start operation is carried out according to the PWM control signal that is based on the voltage of the soft start capacitor; and
the soft start capacitor is charged with a first current when the lighting operation starts, and when the voltage of the soft start capacitor reaches a predetermined voltage, with a second current until the target lamp current is attained, the second current being smaller than the first current.

4. The discharge lamp lighting apparatus of claim 1, wherein:
the soft start circuit includes a soft start capacitor;
a voltage of the soft start capacitor is compared with the triangular signal and the soft start operation is carried out according to the PWM control signal that is based on the voltage of the soft start capacitor; and
at the start of the lighting operation, the soft start capacitor is charged through a predetermined resistance element with a predetermined voltage that is equal to or higher than the reference voltage of the error amplifier.

5. The discharge lamp lighting apparatus of claim 1, wherein:
the soft start circuit includes a soft start capacitor;
a voltage of the soft start capacitor is compared with the triangular signal and the soft start operation is carried out according to the PWM control signal that is based on the voltage of the soft start capacitor; and
at the start of the lighting operation, the soft start capacitor is charged with a first current, and when an output voltage (Vdet) applied to the discharge lamp reaches a predetermined voltage, with a second current until the target lamp current is attained, the second current being smaller than the first current.

6. A semiconductor integrated circuit for controlling a plurality of switching elements that intermittently supply power from a DC power source to a primary winding of a transformer, comprising:
an oscillator configured to generate a triangular signal;
an error amplifier configured to output an error signal representative of a difference between a reference value and a lamp current passing through a secondary winding of the transformer to the discharge lamp;
a control circuit configured to generate a PWM control signal by comparing the triangular signal from the oscillator with the error signal from the error amplifier, and according to the PWM control signal, turn on/off the switching elements;
a connection terminal to which a soft start capacitor is connected; and
a soft start circuit configured to carry out, at the start of a lighting operation, a soft start operation that gradually extends ON intervals of the PWM control signal according to a voltage at the connection terminal to gradually increase the lamp current passed to the discharge lamp up to a target lamp current, the soft start circuit including:
a first constant current circuit configured to provide a first current;
a second constant current circuit configured to provide a second current that is smaller than the first current; and
a charging current switching circuit configured to output the first current from the first constant current circuit to the connection terminal at the start of the lighting operation, and when a voltage at the connection terminal reaches a predetermined voltage, switch the first current from the first constant current circuit to the second current from the second constant current circuit.
